(19) United States
(12) Patent Application Publication
(10) Pub. No.: US 2013/0098711 A1
(43) Pub. Date: Apr. 25, 2013

(54) INTEGRATED ELEVATOR SAFETY SYSTEM

(71) Applicants: Jose Miguel Aguado, Madrid (ES); Luis Marti, Madrid (ES); Jose Luis Vergara, Madrid (ES); Andres Monzon, Madrid (ES); Francisco Luis Sanz, Madrid (ES); Francisco Cervera, Madrid (ES)

(72) Inventors: Jose Miguel Aguado, Madrid (ES); Luis Marti, Madrid (ES); Jose Luis Vergara, Madrid (ES); Andres Monzon, Madrid (ES); Francisco Luis Sanz, Madrid (ES); Francisco Cervera, Madrid (ES)

(73) Assignee: OTIS ELEVATOR COMPANY, Farmington, CT (US)

(21) Appl. No.: 13/698,897

(22) PCT Filed: May 18, 2010
(86) PCT No.: PCT/US10/35254

§ 371 Date: Nov. 19, 2012

(51) Int. Cl. B66B 5/18; B66B 5/04

(52) U.S. Cl. CPC B66B 5/18; B66B 5/044
USPC 187/373

(57) ABSTRACT

A device for stopping an elevator car travelling up or down along guiderails installed in a hoistway includes a chassis mounted on a side of the car, and an overspeed governor, a guiding device and safety gear mounted on the chassis. The overspeed governor detects when a car overspeed is occurring. The guiding device guides the elevator car along a guiderail. The safety gear is vertically aligned with the guiding device on the chassis and stops the elevator car by frictionally engaging the elevator guiderail, which passes through a channel formed in each of the safety gear and the guiding device. The safety gear causes the elevator car to stop by frictionally engaging the guiderail when the overspeed governor detects a car overspeed is occurring.

### BACKGROUND OF THE INVENTION

Typical elevator systems include an elevator car attached to a counterweight by roping. A hoist motor and a brake act together to move the elevator car and counterweight up and down an elevator hoistway, transporting passengers or cargo from one floor to another. An elevator drive and controller provide power to and control operation of the elevator system.

Elevators typically also include a safety system to stop an elevator from traveling at excessive speeds in response to an elevator component breaking or otherwise becoming inoperative. Traditionally, elevator safety systems include a mechanical speed sensing device commonly referred to as an overspeed governor, a tension device and safety gear for selectively frictionally engaging elevator guiderails. The overspeed governor is traditionally mounted either in a machine room or in the top of the hoistway. The safety system is mounted in the car, and the tension device, usually a rope or other linkage connects the system with the governor. When the governor detects a dangerous situation due to excessive travelling speed, it sends a signal to the safety gear through the tension device. The safety gear then engages the guiderails, and stops the elevator car.

### BRIEF SUMMARY OF THE INVENTION

A device for stopping an elevator car travelling up or down along guiderails installed in a hoistway includes a chassis mounted on a side of the car, and an overspeed governor, a guiding device and safety gear mounted on the chassis. The overspeed governor detects when a car overspeed is occurring. The guiding device guides the elevator car along a guiderail. The safety gear is vertically aligned with the guiding device on the chassis and stops the elevator car by frictionally engaging the elevator guiderail, which passes through a channel formed in each of the safety gear and the guiding device. The safety gear causes the elevator car to stop by frictionally engaging the guiderail when the overspeed governor detects a car overspeed is occurring.

### BRIEF DESCRIPTION OF THE DRAWINGS

FIG. 1A is a perspective view of an elevator system with an integrated safety device according to the current invention.

FIG. 1B is a front view of the elevator of FIG. 1A, showing the integrated safety device.

FIG. 2A is a perspective view of the first chassis of the integrated safety device.

FIG. 2B is a perspective view of the first chassis of the integrated safety device with a cover over the overspeed governor.

FIGS. 3A-3B are front and back views, respectively, of the overspeed governor of FIG. 2A when an overspeed condition is not occurring.

FIGS. 4A-4B are front and back views, respectively, of the overspeed governor of FIG. 2A when an overspeed condition is occurring.

FIG. 5 is a perspective view of the second chassis of the integrated safety device of FIG. 1B.

### DETAILED DESCRIPTION

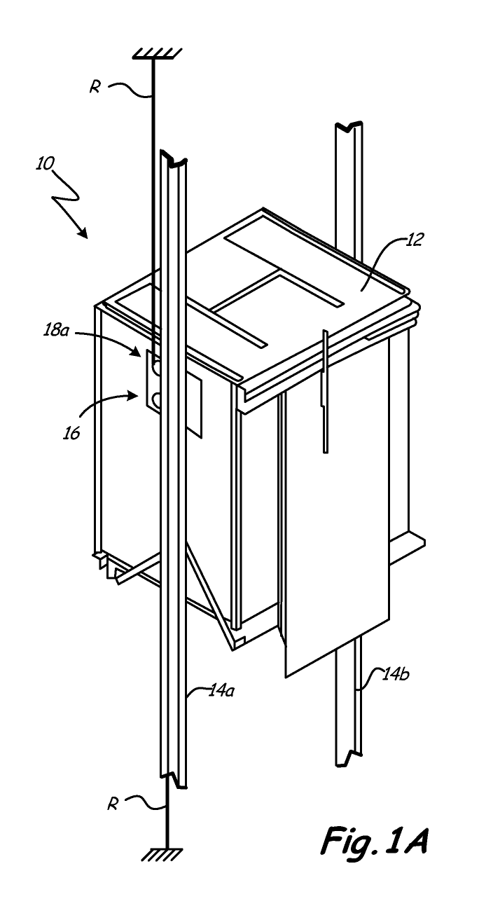

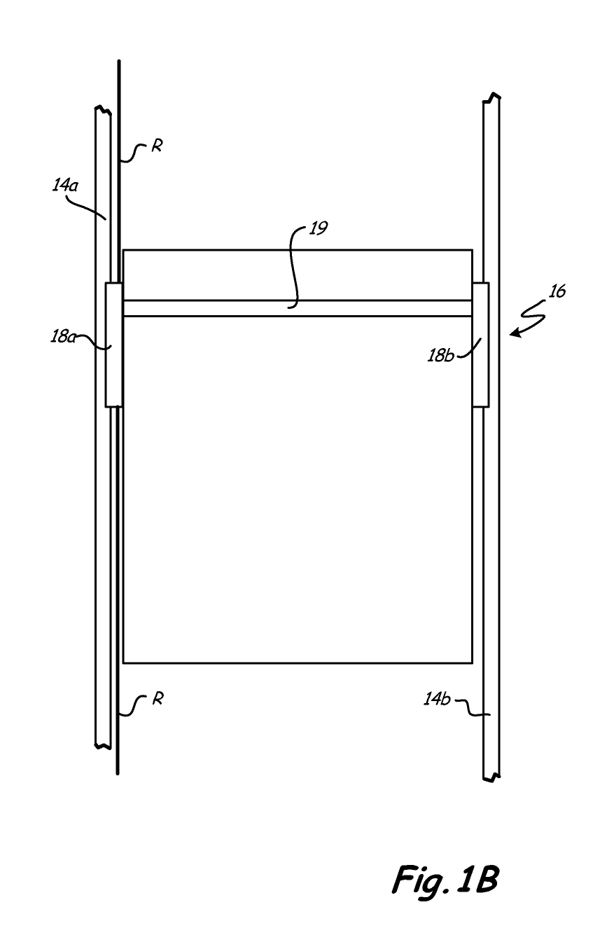

FIG. 1A is a perspective view of an elevator system with an integrated safety device according to an embodiment of the present invention. FIG. 1B is a front view of the elevator of FIG. 1A with the integrated safety device. Elevator system 10 includes elevator car 12, guiderails 14a, 14b, and integrated safety device 16. Integrated safety device 16 includes first chassis 18a attached to one side of car 12; second chassis 18b attached to the other side of the car 12; and connection bar 19 extending between first chassis 18a and second chassis 18b.

First chassis 18a is bolted onto one side of elevator car 12 and is aligned with guiderail 14a, and second chassis 18b is bolted onto the other side of the elevator car 12 and is aligned with guiderail 14b. Governor rope R is anchored to the top and the bottom of the hoistway, and passes through first chassis 18a. Connection bar 19 connects to first chassis 18a and second chassis 18b, and can be located above a passenger ceiling in elevator car 12 (but not above car 12).

Elevator car 12 travels on or is slidably or rollingly connected to guiderails 14a, 14b and travels inside a hoistway (not shown). Both chassis 18a, 18b function as guiding devices to keep car 12 slidably or rollingly connected to guiderails. Both chassis 18a, 18b also act as safeties to stop car 12 in an overspeed condition. First chassis 18a serves as master, detects when an overspeed condition is occurring and acts to stop car 12. Connection bar 19 mechanically links first chassis 18a to second chassis 18b so that second chassis 18b acts to stop car 12 when first chassis 18a acts to stop car 12 in an emergency or when an overspeed is occurring.

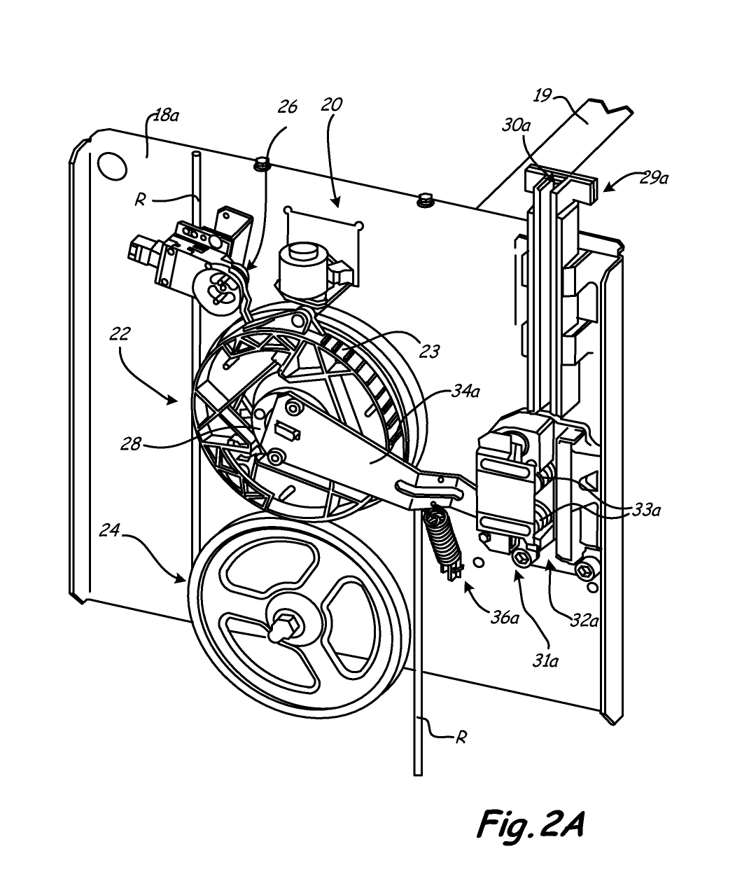

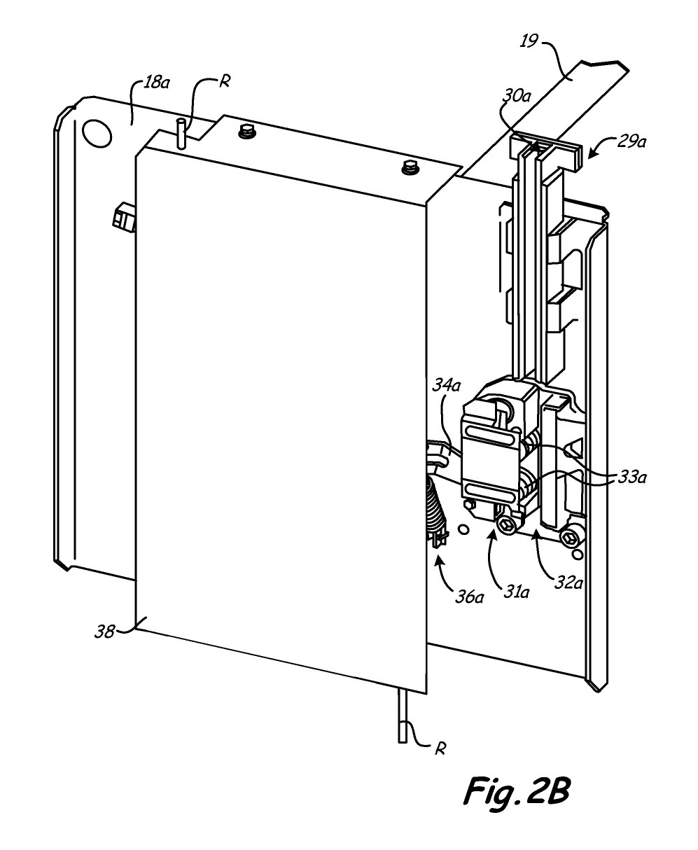

FIG. 2A is a perspective view of first chassis 18a of integrated safety device 16. First chassis 18a includes overspeed governor 20 (which includes tripping sheave 22, governor tripping mechanism 23, idler sheave 24, overspeed switch 26, and free wheeling disc 28), first guiding device 29a with channel 30a, first safety gear 31a with channel 32a and rollers 33a, first safety lever 34a and stabilizing device 36a. Also shown in FIG. 2A is governor rope R and connection bar 19.

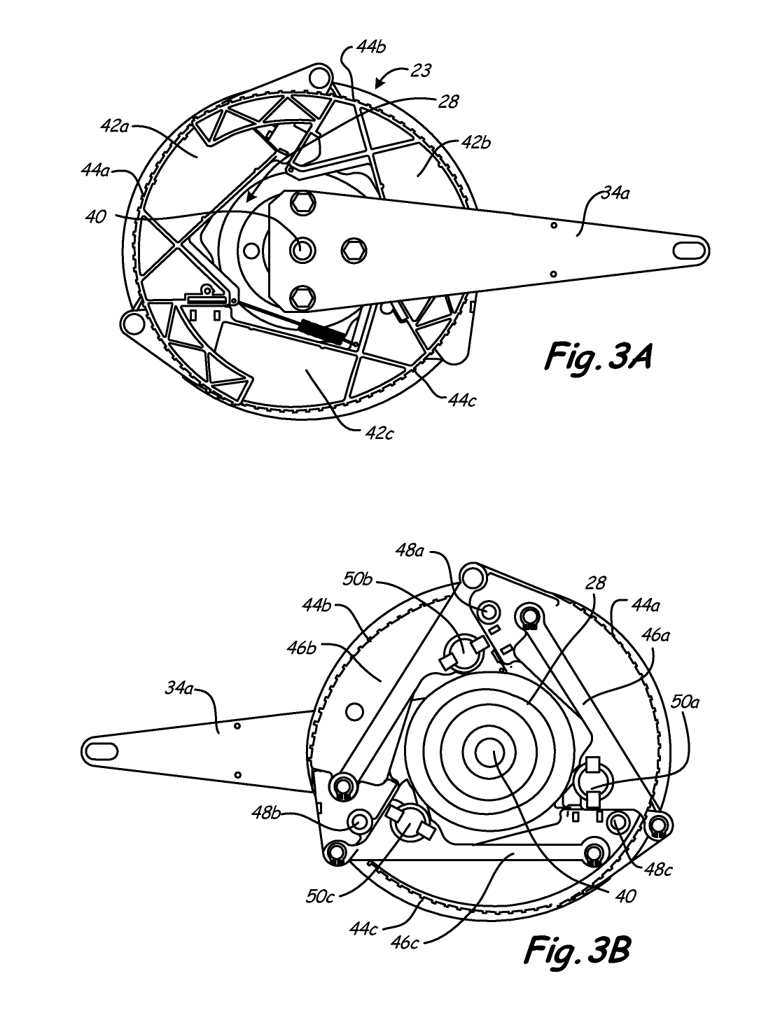

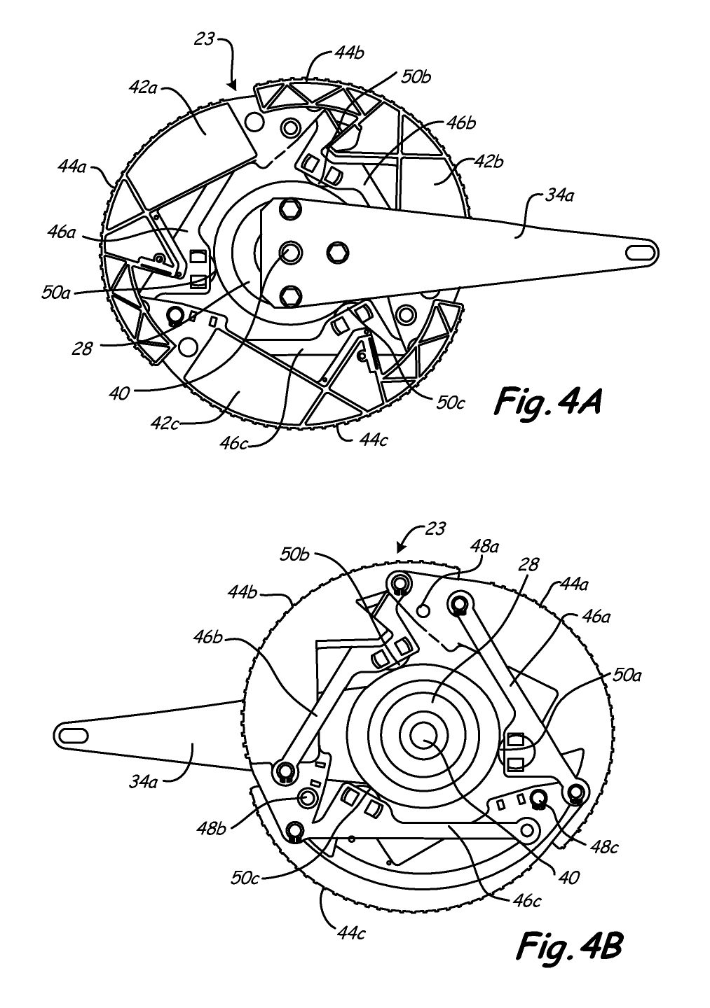

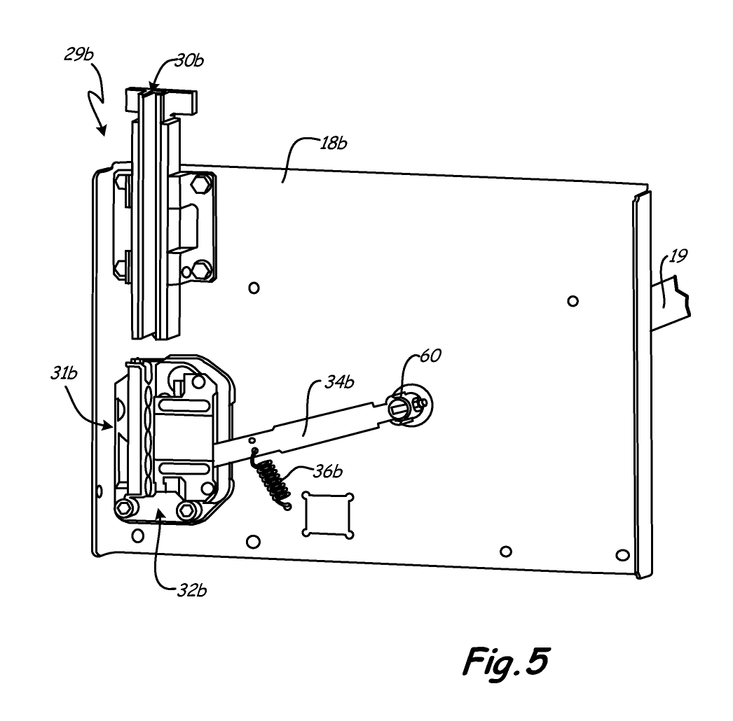

First chassis 18a can be sheet metal, and includes holes for fastening first chassis 18a to the elevator car, as well as holes for attaching overspeed governor 20, first guiding device 29a and first safety gear 31a (amongst other parts) to it. Governor tripping mechanism 23 is attached to tripping sheave 22, which is rotatably mounted to first chassis 18a. Governor tripping mechanism 23 is made of plastic to minimize noise of overspeed governor 20. Idler sheave 24 of overspeed governor 20 is also rotatably mounted to first chassis 18a, at a position below tripping sheave 22. Overspeed switch 26 is attached to first chassis 18a. Governor rope R is anchored at the top and bottom of elevator hoistway (see FIG. 1A) and travels around tripping sheave 22 and idler sheave 24. First guiding device 29a is attached to first chassis 18a and is aligned relative to first guiderail 14a, so that guiderail 14a slides through channel 30a of guiding device 29a as the elevator car moves up and down in the hoistway. While a sliding guide is shown, first guiding device 29a can be a roller guide. First safety gear 31a is attached to first chassis 18a and is aligned relative to first guiding device 29a so that rail 14a may pass through channel 30a of guiding device 29a and goes through channel 32a of safety gear 31a and so that rollers 33a can properly engage rail 14a in an overspeed or emergency condition, as described in further detail below. Channel 32a includes rollers 33a on one side. First safety lever 34a is connected to free wheeling disc 28 of governor tripping mechanism 23. When an overspeed condition is occurring, free wheeling disc 28 is coupled to governor tripping mechanism 23 through rollers 50a-50c (as described in more detail below with respect to FIGS. 3A-4B). First safety lever 34a is also connected to first safety gear 31a. Stabilizing device 36a is connected to first safety lever 34a to stabilize first safety lever 34a when an overspeed is not occurring (and therefore free wheeling disc 28 and first safety lever 34a are not coupled to governor tripping mechanism 23). In this embodiment, stabilizing device 36a is a spring that biases first safety lever 34a towards stabilizing device 36a. Connection bar 19 connects first safety lever 34a to second safety lever 34b on second chassis 18b, located on the other side of the car (see FIGS. 1B, 5).

First safety gear 31a acts (along with second safety gear 31b, shown in FIG. 5) as a last emergency means to stop elevator car 12. As mentioned above, rail 14a passes through channel 32a of safety gear 31a. Car 12 is stopped when rail 14a is frictionally engaged by rollers 33a of safety gear 31a, so that the rail is connected to rollers 33a and the side of channel 32a opposing rollers. This connection or frictional engagement is due to the movement of rollers 33a into channel 32a towards rail 14a, which is caused by movement of first safety lever 34a, triggered by an overspeed condition.

First guiding device 29a guides the elevator car along guiderail 14a in the hoistway (see FIG. 1A), with guiderail 14a going through channel 30a as described above.

Overspeed governor 20 acts to detect an overspeed condition of the elevator car. Governor rope R is statically anchored at the top and bottom of the hoistway (see FIG. 1A), and copies the car speed to overspeed governor 20 by looping around tripping sheave 22 and idler sheave 24. Rope R, coming from the top of the hoistway, passes under idler sheave 24, around, and over tripping sheave 22, and then travels down to an anchor at the bottom of the hoistway. This configuration ensures that tripping sheave 22 and idler sheave 24 rotate. Governor tripping mechanism 23 rotates about the same axis as tripping sheave 22, and includes masses and mass supports which are coupled together. The operation of governor tripping mechanism 23 is discussed in detail further below in relation to FIGS. 3A-4B. As tripping sheave 22 rotates at angular velocities within a defined range (due to governor rope R), masses remain coupled and governor tripping mechanism 23 rotates with tripping sheave 22 without engaging overspeed switch 26 or free wheeling disc 28. Governor tripping mechanism 23 is actuated when the force coupling the masses is overcome at a set angular velocity of tripping sheave 22. In particular, as the centrifugal force on the masses exceeds the force created by the coupling, mass supports move radially outward as a function of angular velocity, trip overspeed switch 26 and engage free wheeling disc 28 (attached to first safety lever 34a), coupling it to governor tripping mechanism 23.

When overspeed switch 26 is tripped, elevator power is shut down. When the free wheeling disc 28 is coupled to governor tripping mechanism 23, it moves with governor tripping mechanism 23 (which is moving with tripping sheave 22). First safety lever 34a is attached to free wheeling disc 28, and therefore also moves with free wheeling disc 28 and governor tripping mechanism 23 when free wheeling disc 28 is coupled to governor tripping mechanism 23 (in an overspeed condition). This counterclockwise rotational movement of first safety lever 34a overcomes the force of stabilizing device 36a holding lever 34a in a certain position. The counterclockwise rotation of safety lever in turn, causes rollers 33a inside first safety gear 31a to move toward rail 14a in channel 32a, frictionally engaging guiderail 14a and stopping the elevator car. When an overspeed condition is not occurring, i.e., during normal elevator operation, free wheeling disc 28 is not coupled to governor tripping mechanism 23, and first safety lever 34a is held in place by stabilizing device 36a. In the illustrative embodiment of FIG. 2A, stabilizing device 36a is a spring (but could be any suitable type of stabilizing device, such as a solenoid). Stabilizing device 36a works to prevent false trips of first safety lever 34a (thereby preventing engagement of first safety gear 31a when an overspeed is not occurring).

As shown in FIG. 1B and FIG. 2A, connection bar 19 connects first safety lever 34a on one end to a second safety gear 31b (on second chassis 18b) on the other end. In particular, connection bar 19 acts to transmit rotational movement of first safety lever 34a when engaged (when an overspeed condition is occurring) to second safety lever 34b of second safety gear 31b attached to second chassis 18b.

FIG. 2B is a perspective view of the first chassis of the integrated safety device with a cover over the overspeed governor. FIG. 2B shows first chassis 18a with cover 38 over overspeed governor, governor rope R, first guiding device 29a with channel 30a, first safety gear 31a with channel 32a and rollers 33a, first safety lever 34a, and stabilizing device 36a.

Cover 38 is attached to first chassis 18a and covers overspeed governor 20 to protect it. This protection of overspeed governor by cover 38 is especially useful, for example, when a building is under construction and the elevator is in use before it is enclosed in and protected by a hoistway. Cover 38 is generally sheet metal, but can be any other material which will provide protection to overspeed governor 20 without being too heavy for mounting on first chassis 18a.

FIG. 3A is a front view of the overspeed governor and safety lever of FIG. 2A when an overspeed condition is not occurring. FIG. 3B is a back view of the overspeed governor and safety lever of FIG. 3A. FIGS. 3A-3B show governor tripping mechanism 23 with axis of rotation 40, first mass 42a, second mass 42b, third mass 42c, first mass support 44a, second mass support 44b, third mass support 44c, first link 46a, second link 46b, third link 46c, first pivot point 48a, second pivot point 48b, third pivot point 48c, first roller 50a, second roller 50b, third roller 50c; first safety lever 34a; and free wheeling disc 28. Overspeed governor tripping mechanism 23 rotates counterclockwise about tripping sheave axis of rotation 40 and includes first mass 42a, second mass 42b, third mass 42c, first mass support 44a, second mass support 44b, and third mass support 44c. First mass 42a is attached to first mass support 44a. Second mass 42b is attached to second mass support 44b. Third mass 42c is attached to third mass support 44c. First mass support 44a is pivotally attached to tripping sheave 22 (shown in FIG. 2A) at a first mass support pivot point 48a. Second mass support 44b is pivotally attached to tripping sheave 22 at a second mass support pivot point 48b. Third mass support 44c is pivotally attached to tripping sheave 22 at a third mass support pivot point 48c. First mass support 44a is pivotally attached to second mass support 44b by a second link 46b, which includes second roller 50b. Second mass support 44b is pivotally attached to third mass support 44c by a third link 46c, which includes roller 50c. Third mass support 44c is pivotally attached to the first mass support 44a by first link 46a, which includes roller 50a.

Governor tripping mechanism 23 also includes a releasable non-elastic coupler (not shown) between one of the mass supports 44a, 44b, 44c and tripping sheave 22, or between two of the mass supports, which resists the centrifugal force created by the rotation of the sheave (not shown). For example, the coupler can be a magnet, as shown in FIG. 5 of U.S. Pat. App. No. 2010/0059319, which is herein incorporated by reference. As the sheave rotates at angular velocities within a defined range, the coupler holds the coupled parts together, and governor tripping mechanism 23 rotates with tripping sheave 22. Governor tripping mechanism 23 is actuated when the force provided by the coupler is overcome by the centrifugal force on masses 42a, 42b, and 42c at a set angular velocity of tripping sheave 22, causing masses 42a, 42b, 42c and supports 44a, 44b, 44c to move radially outward.

FIG. 4A shows a front view of the overspeed governor of FIG. 3A when an overspeed is occurring. FIG. 4B shows a back view of the overspeed governor of FIG. 4A. FIGS. 4A-4B show governor tripping mechanism 23 with axis of rotation 40, first mass 42a, second mass 42b, third mass 42c, first mass support 44a, second mass support 44b, third mass support 44c, first link 46a, second link 46b, third link 46c, first pivot point 48a, second pivot point 48b, third pivot point 48c, first roller 50a, second roller 50b, third roller 50c; first safety lever 34a; and free wheeling disc 28.

As mentioned above, when an overspeed is occurring, the force by which the coupler (not shown) holds masses 42a, 42b and 42c together is overcome, and masses 42a, 42b, 42c and supports 44a, 44b, 44c move radially outward as a function of angular velocity. As masses 42a, 42b, 42c and supports 44a, 44b, 44c move radially outward, first link 46a, second link 46b and third link 46c move due to their respective connections to supports 44a, 44b, 44c. This movement of links 46a, 46b, 46c results in rollers 50a, 50b, 50c coming into contact with freewheeling disc 28. The contact of rollers 50 with disc 28 couples free wheeling disc 28 to governor tripping mechanism 23. Once it is coupled to the governor tripping mechanism 23, free wheeling disc 28 moves with it. First safety lever 34a, which is attached to free wheeling disc 28, also moves, engaging first safety gear 31a (see FIGS. 2A and 2B).

Connecting the masses 42a, 42b, 42c, supports 44a, 44b, 44c, and links 46a, 46b, 46c to form the generally circular governor mechanism 23 prescribes the motion of the mass supports 44a, 44b, 44c such that when in a non-actuated state, mass supports 44a, 44b, 44c are radially spaced about the sheave axis of rotation 40 and, when actuated, mass supports 44a, 44b, 44c move radially outward as a function of angular velocity to substantially create the circumference of a generally circular shape until the outer arcuate edges of the mass supports 44a, 44b, 44c trip overspeed switch 26 (FIG. 2A) and rollers 50a, 50b, 50c of links 46a, 46b, 46c move radially inward and engage free wheeling disc 28. When overspeed switch 26 is engaged, elevator power is shut down. Because governor tripping mechanism 23 forms a substantially contiguous circle at the outer edges of mass supports 44a, 44b, 44c and provides the controlled motion previously described, once governor tripping mechanism 23 is actuated, it will almost immediately trip overspeed switch 26 and engage freewheeling disc 28 regardless of the angular position.

The overspeed governor of FIGS. 3A-4B is shown for example purposes only. A different type of overspeed governor can be used to detect an overspeed condition and engage a safety lever which causes the safety gear(s) to stop the elevator car.

FIG. 5 illustrates second chassis 18b of integrated safety device 16, according to an embodiment of the current invention, and includes second guiding device 29b with channel 30b, second safety gear 31b with channel 32b, second safety lever 34b, second stabilizing device 36b and connection bar 19. Second chassis 18b can be sheet metal, and includes holes for fastening chassis 18b to the elevator car on the opposite lateral wall of car 12 than first chassis 18a, as well as holes for attaching second guiding device 29b, second safety gear 31b and second safety lever 34b to chassis 18b. Second guiding device 29b is attached to second chassis 18b and is aligned relative to second guiderail 14b (shown in FIG. 1B) so that guiderail 14b may pass through channel 30b of second guiding device 29b. While a sliding guide is shown, second guiding device 29b can also be a roller guide. Second safety gear 31b is attached to second chassis 18b and is aligned relative to second guiding device 29b, so that guiderail 14b passes through channel 32b of second safety gear 31b and through channel 30b of second guiding device 29b. Second safety lever 34b connects to second safety gear 31b and to connection bar 19. Connection bar 19 can pass above the car ceiling to connect first safety lever 34a on first chassis 18a to end 60 of second safety lever 34b on second chassis 18b.

Second guiding device 29b guides the elevator car along second guiderail 14b in the hoistway (see FIG. 1B) with guiderail 14b going through channel 30b, as described above. Second guiding device 29b also helps to ensure second safety gear 31b is properly aligned with second guiderail 14b, which also passes through channel 32b of second safety gear 31b, so that second safety gear 31b frictionally engages second elevator guiderail 14b to assist in stopping the elevator car in an emergency. Connection bar 19 mechanically links second safety lever 34b (at end 60) to first safety lever 34a (as shown in FIG. 2A). When an overspeed is detected, and free wheeling disc 28 and first safety lever 34a are both coupled to governor tripping mechanism 23, first safety lever 34a moves, causing rollers 33a of first safety gear 31a to frictionally engage guiderail 14a, as described above. Second safety lever 34b, connected to first safety lever 34a by connection bar 19, also moves, causing rollers (not shown) in second safety gear 31b to move into channel 32b and frictionally engage guiderail 14b. The frictional engagement of guiderail 14b by the rollers of second safety gear 31b is done in the same manner as described in relation to the frictional engagement of guiderail 14a by rollers 33a of first safety gear 31a (FIG. 2A). Stabilizing device 36b is connected to second safety lever 34b to stabilize second safety lever 34b when an overspeed is not occurring. In this embodiment stabilizing device 36b is a spring, biasing second safety lever 34b toward stabilizing device 36b.

Second chassis 18b, with second guiding device 29b, second safety gear 31b and second safety lever 34b, assists first chassis 18a in stopping the elevator car when an overspeed condition has been detected. Since connection bar 19 mechanically links second safety lever 34b to first safety lever 34a so that second safety lever 34b causes second safety gear 31b to frictionally engage guiderail 14b when first safety gear 31a frictionally engages first guiderail 14a (in an overspeed condition), the need for an overspeed governor 20 on second chassis 18b to detect when an overspeed is occurring is eliminated. The inclusion of second chassis 18b on the opposite side of elevator car 12 from first chassis 18a assists the car in coming to a more smooth and efficient stop in an emergency situation (than if only first chassis 18a were present on elevator car 12).

The inclusion of first chassis 18a with overspeed governor 20, first guiding device 29a, first safety gear 31a, and first safety lever 34a; second chassis 18b with second guiding device 29b, second safety gear 31b, second safety lever 34b; and connection bar 19 connecting first safety lever 34a and second safety lever 34b, provides an elevator system with a reliable and compact safety device that is simple to put together and install. First chassis 18a serves as a common mounting reference for all elements attached to first chassis 18a (overspeed governor 20, first guiding device 29a, first safety gear 31a and first safety lever 34a). Similarly, second chassis 18b serves as a common mounting reference for elements attached to second chassis 18b (second guiding device 29b, second safety gear 31b and second safety lever 34b). The common mounting reference for each individual chassis 18a, 18b allows for assembly and verification of each chassis 18a, 18b and its parts in the factory. This also ensures that all elements on each respective chassis 18a, 18b are correctly aligned relative to each other, minimizing additional adjustments and erection time when installing an elevator system.

Furthermore, by positioning overspeed governor 20 on first chassis 18a, it can be directly linked to first safety gear 31a, minimizing delays in activating first safety gear 31a after an overspeed condition has been detected. In past elevator systems, the overspeed governor is often mounted at the top of the hoistway or in a machine room, requiring the overspeed governor to be linked to the safety gear with a rope, which sometimes caused delays in activating the safety gear after detection of an overspeed due to the length and elasticity of the rope. By positioning overspeed governor 20 adjacent to first safety gear 31a on first chassis 18a, they can be directly linked (by first safety lever 34a) minimizing delays in activating first safety gear 31a when an overspeed condition occurs. Second safety gear 31b can also be activated with minimal delays due to the connection of first safety lever 34a and second safety lever 34b by connection bar 19.

Another important advantage of integrated elevator safety device 16 is a reduction in the space required for the overspeed governor, guiding device and safety gear. Previously, the overspeed governor, guiding device and safety gear were each mounted separately, taking up room in separate locations (the overspeed governor in the hoistway or a machine room, with the guiding device and safety gear on the car). By mounting the overspeed governor, guiding device and safety gear on a common first chassis and mounting a second guiding device and second safety gear on a common second chassis, each chassis to be mounted on the elevator car, the amount of space in the hoistway needed for the various safety devices of the elevator is reduced.

A further advantage of the integrated safety device of the current invention is the cost reductions created by the reduction of space needed as well as the reduction in time for installing the system. The installation of two chassis, each of which already has the safety devices aligned and verified, saves time and work that would otherwise have to be spent installing the overspeed governor, guiding devices and safety gears all separately, aligning them each properly and linking them together.

While the invention has been described with reference to an exemplary embodiment(s), it will be understood by those skilled in the art that various changes may be made and equivalents may be substituted for elements thereof without departing from the scope of the invention. For example, a different type of overspeed governor or a different safety lever could be used. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A device for stopping an elevator car travelling along guiderails installed in a hoistway, the device comprising:
a first chassis mounted on one side of the elevator car;
an overspeed governor, mounted on the first chassis, to detect when a car overspeed is occurring;
a first guiding device, mounted on the first chassis, to guide the elevator car along a first guiderail; and
first safety gear, mounted on the first chassis aligned with the first guiding device, to stop the elevator car by frictionally engaging the first elevator guiderail when a car overspeed is detected by the overspeed governor;
a first safety lever connecting the overspeed governor to first safety gear to cause first safety gear to frictionally engage the first guiderail when the overspeed governor detects a car overspeed is occurring;
a first stabilizing device to stabilize the first safety lever steady while the elevator is in normal operation;
a second chassis mounted on a side of elevator car opposite the first chassis and aligned relative to a second guiderail;
a second guiding device mounted on the second chassis to guide the elevator car along the second guiderail; and
second safety gear, mounted on the second chassis aligned with the second guiding device, to stop the elevator car by frictionally engaging the second elevator guiderail when a car overspeed is detected by the overspeed governor, wherein the first stabilizing device is one of a spring or a solenoid.

2.-5. (canceled)

6. The device of claim 1, wherein the second guiding device is mounted on the second chassis above the second safety gear such that a channel formed in the second guiding device and a channel formed in second safety gear are vertically aligned, allowing the second guiderail to pass through the channels.

7. The device of claim 1, further comprising:
a second safety lever connected to second safety gear to cause second safety gear to frictionally engage the second guiderail when the overspeed governor detects a car overspeed is occurring.

8. The device of claim 7 further comprising:
a connection bar for connecting the first safety lever to the second safety lever so that the second safety lever causes second safety gear to frictionally engage the second guiderail when the first safety lever causes first safety gear to frictionally engage the first guiderail.

9. The device of claim 8, wherein the connection bar passes above a ceiling in the car between the first safety lever and the second safety lever.

10. The device of claim 7 further comprising:
a second stabilizing device to stabilize the second safety lever steady while the elevator is in normal operation.

11. The device of claim 10, wherein the second stabilizing device is one of a spring or a soleniod.

12. The device of claim 1, wherein the overspeed governor comprises:
a tripping sheave rotatably mounted to the chassis;
a governor with rollers, connected to the tripping sheave, the governor configured to increase in diameter due to centrifugal force at a certain overspeed velocity;
an idler sheave rotatably mounted to the chassis;
a governor rope winding around the tripping sheave and the idler sheave and attached to a top and a bottom of the hoistway to copy car speed to the governor;
a tripping switch mounted to the chassis that is actuated when the governor has increased in diameter, and when actuated, shuts down power to the elevator; and
a free wheeling disc attached to the first safety lever, that couples the first safety lever to the governor by contact with the rollers when the governor has increased in diameter due to an overspeed condition.

13. The device of claim 1, wherein the guiding device is mounted on the first chassis above first safety gear such that a channel formed in the guiding device and a channel formed in first safety gear are vertically aligned, allowing first guiderail to pass through said channels.

14. The device of claim 1, wherein the overspeed governor is mounted on the first chassis alongside first safety gear and the first guiding device.

15. The device of claim 1, wherein the overspeed governor is a centrifugally actuated governor.

16. The device of claim 1, wherein the overspeed governor is made of plastic.

17. The device of claim 1 further comprising:
a cover mounted to the first chassis to protect the overspeed governor.

18. The device of claim 17, wherein the cover is made of sheet metal.

19. An elevator system with an integrated emergency stopping device, the system comprising:
an elevator car for traveling up and down along first and second guiderails installed in a hoistway;
a first chassis mounted on one side of the car, said first chassis having mounted thereon: an overspeed governor to detect when a car overspeed is occurring; a first guiding device to guide the elevator car along the first guiderail; first safety gear, vertically aligned with the first guiding device that stops the elevator car by frictional engagement with the first elevator guiderail; and a first safety lever connecting the overspeed governor to first safety gear to initiate the frictional engagement of first safety gear with the first guiderail when the overspeed governor detects a car overspeed is occurring; and
a second chassis mounted on an opposite side of the elevator car, the second chassis having mounted thereon: a second guiding device to guide the elevator car along the second guiderail; second safety gear vertically aligned with the second guiding device that stops the elevator car by frictional engagement with second elevator guiderail; and a second safety lever connecting first safety gear to second safety gear to cause the second safety gear to frictionally engage the second guiderail.

20. The system of claim 19 further comprising:
a connection bar connecting the first safety lever to the second safety lever so that the second safety lever causes second safety gear to frictionally engage the second guiderail when the first safety lever causes first safety gear to frictionally engage the first guiderail.

21. The elevator system of claim 19, wherein the overspeed governor is made of plastic.

22. The elevator system of claim 19 further comprising:
a cover mounted to the first chassis to protect the overspeed governor.

23. The elevator system of claim 19 further comprising:
a first stabilizing device to stabilize the first safety lever steady while the elevator is in normal operation.

24. The elevator system of claim 23 further comprising:
a second stabilizing device to stabilize the second safety lever while the elevator is in normal operation.

25. The elevator system of claim 24, wherein each stabilizing device is one of a spring and a solenoid.
